(19) United States
(12) Patent Application Publication
(10) Pub. No.: US 2019/0254933 A1
(43) Pub. Date: Aug. 22, 2019

(54) FLAVORED TEETHER ASSEMBLY

(71) Applicant: Gregory William Lake, Clayton, DE (US)

(72) Inventor: Gregory William Lake, Clayton, DE (US)

(21) Appl. No.: 15/902,562

(22) Filed: Feb. 22, 2018

(51) Int. Cl. A61J 17/00

(52) U.S. Cl. CPC A61J 17/001

(57) ABSTRACT

An improved pacifier assembly including a pacifier having at least one dissolving flavor packet to provide a tasty incentive for babies to use whereby a developing infant determines flavor differences thereby providing flavor variance for a child to recognize, stimulates brain function and encourages further cognitive growth.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of pacifier devices and more specifically relates to an improved pacifier assembly including a pacifier having at least one dissolving flavor packet to provide a tasty incentive for babies to use whereby a developing infant determines flavor differences thereby providing flavor variance for a child to recognize, stimulates brain function and encourages further cognitive growth.

### 2. Description of the Related Art

A pacifier is a rubber, plastic, or silicone nipple given to an infant to suck upon. In its standard appearance it has a teat, mouth shield, and handle. The mouth shield and/or the handle is large enough to avoid the danger of the child choking on it or swallowing it. Babies have a natural tendency to want to suck. Some people tend to over feed their babies to keep them from crying and keep them more content.

Various attempts have been made to solve problems found in pacifier art. Among these are found in: U.S. Pat. No. 20130331888 to Michelle Antinnes; U.S. Pat. No. 5,013,321 to Benjamin F MacVane; and U.S. Pat. No. 20130085475 to Hermon McNac. This prior art is representative of flavored pacifiers.

Ideally, an improved pacifier assembly should be user-friendly and safe in-use and, yet should operate reliably and be manufactured at a modest expense. Thus, a need exists for an improved pacifier assembly including a pacifier having at least one dissolving flavor packet to provide a tasty incentive for babies to use whereby a developing infant determines flavor differences thereby providing flavor variance for a child to recognize, stimulates brain function and encourages further cognitive growth and to avoid the above-mentioned problems.

### BRIEF SUMMARY OF THE INVENTION

In view of the foregoing disadvantages inherent in the known pacifier device art, the present invention provides an improved pacifier assembly (Entitled Flavored Teether Assembly). The general purpose of the present invention, which will be described subsequently in greater detail is to provide an improved pacifier assembly including a pacifier having at least one dissolving flavor packet to provide a tasty incentive for babies to use whereby a developing infant determines flavor differences thereby providing flavor variance for a child to recognize, stimulates brain function and encourages further cognitive growth

An improved pacifier assembly comprising: a pacifier and a storage cup. The pacifier includes a handle assembly a teether member; at least one flavor packet; a flavor packet cap; and a bottom holder member.

The handle assembly includes a base plate having an outer ridge and an aperture therethrough; a cap member having a tab member; and a handle member. The tab member is adapted to be grabbed by a user and used to pull, push, and turn the cap member. Wherein the cap member is adapted to releasably connect with the base plate to removably cover the aperture of the base plate. Wherein the handle member is connected to an upper surface of the base plate.

The teether member includes: a base portion having an outer ridge and an aperture therethrough; and a nipple portion having an outer membrane. Wherein the outer membrane forms an interior volume. Wherein the outer membrane includes a plurality of perforations therethrough. Wherein the nipple portion is connected to the base portion surrounding the aperture to thereby allowing a flavor packet to pass therethrough and into said interior volume thereof.

The at least one flavor packet includes a main material and a chemical additive. Wherein the main material is adapted to dissolve when mixed with saliva. Wherein the chemical additive is adapted to provide a chosen flavor. Wherein the chemical additive is mixed with the main material. Wherein each of the at least one flavor packet is adapted to be removably placed one at a time within the interior volume of the nipple portion, such that when mixed with saliva the flavor packet dissolves and flows through the plurality of perforations of the nipple portion.

The flavor packet cap including an aperture therethrough. Wherein the flavor packet cap is adapted to reside between the handle assembly and the teether member.

The bottom holder member includes an outer ridge and an aperture therethrough. Wherein the aperture is adapted to allow the nipple portion of the teether member to pass therethrough. Wherein the bottom holder member is adapted to releasably connect with the outer ridge of the base plate of the handle assembly and hold the teether member and the flavor packet cap therebetween.

The storage cup includes a bottom wall and at least one side wall. Wherein the at least one side wall is connected to the bottom wall and extending upwardly therefrom and includes an upper edge portion. Wherein the bottom wall and the at least one side wall form an interior volume therein. Wherein a bottom portion of the bottom holder member of the pacifier is adapted to releasably engage the upper edge portion of the at least one side wall of the storage cup, such that when in a stored configuration the nipple portion of the teether member is adapted to extend into the interior volume of the storage cup.

The present invention holds significant improvements and serves as an improved pacifier assembly. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, an Improved Pacifier Assembly (Entitled Flavored Teether Assembly), constructed and operative according to the teachings of the present invention.

FIG. 1A shows a perspective view illustrating an Improved Pacifier Assembly having a first size smaller nipple portion for infants 0-6 months according to an embodiment of the present invention.

FIG. 1B shows a perspective view illustrating an Improved Pacifier Assembly having a second size larger nipple portion for children 6-18 months according to an embodiment of the present invention.

FIG. 2 is a perspective view illustrating a pacifier includes a handle assembly a teether member; at least one flavor packet; a flavor packet cap; and a bottom holder member of the according to an embodiment of the present invention of FIG. 1.

FIG. 3 is another perspective view illustrating the Improved Pacifier Assembly according to an embodiment of the present invention of FIG. 1.

FIG. 4A is perspective view illustrating 14 flavor packets of the Improved Pacifier Assembly according to an embodiment of the present invention of FIG. 1.

FIG. 4B is perspective view illustrating 7 flavor packets of the Improved Pacifier Assembly according to an embodiment of the present invention of FIG. 1.

FIG. 5A is a sectional view illustrating the Improved Pacifier Assembly according to an embodiment of the present invention of FIG. 1.

FIG. 5B is a perspective view illustrating a storage cup of the Improved Pacifier Assembly according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a pacifier device and more specifically relates to an Improved Pacifier Assembly (Entitled Flavored Teether Assembly). The general purpose of the present invention, which will be described subsequently in greater detail is to provide an improved pacifier assembly including a pacifier having at least one dissolving flavor packet to provide a tasty incentive for babies to use whereby a developing infant determines flavor differences thereby providing flavor variance for a child to recognize, stimulates brain function and encourages further cognitive growth.

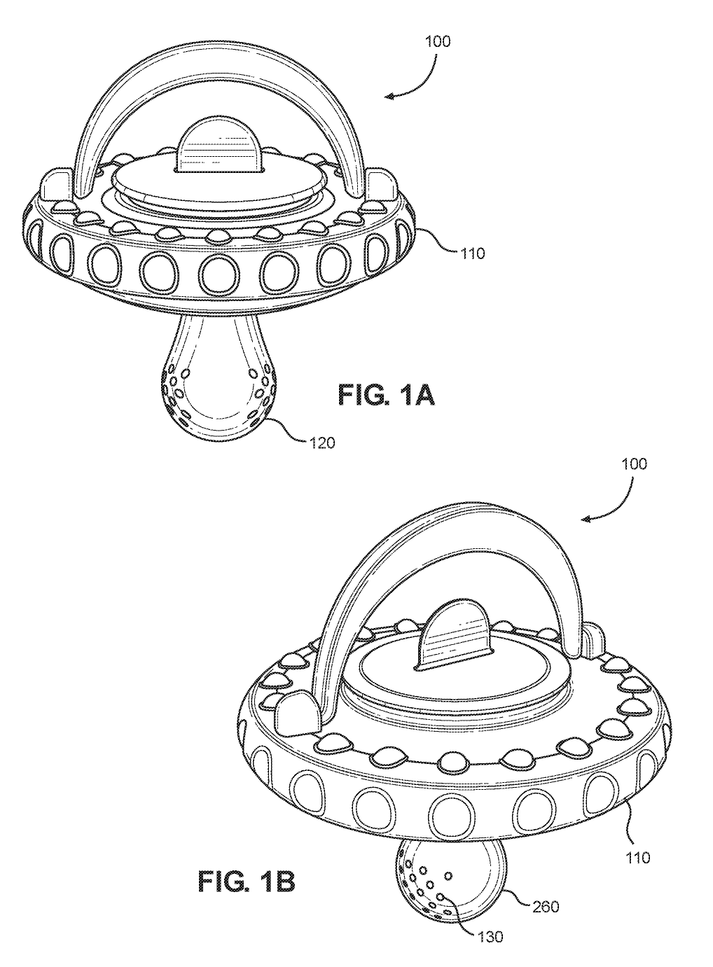

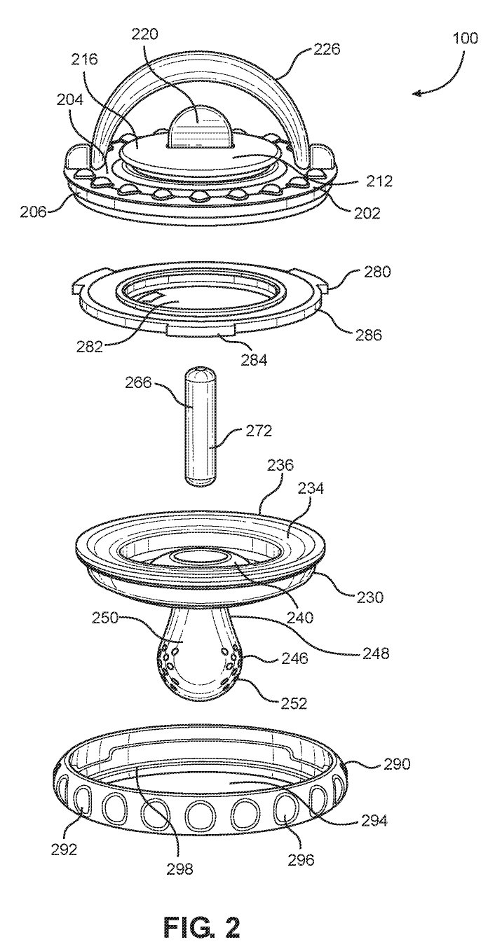

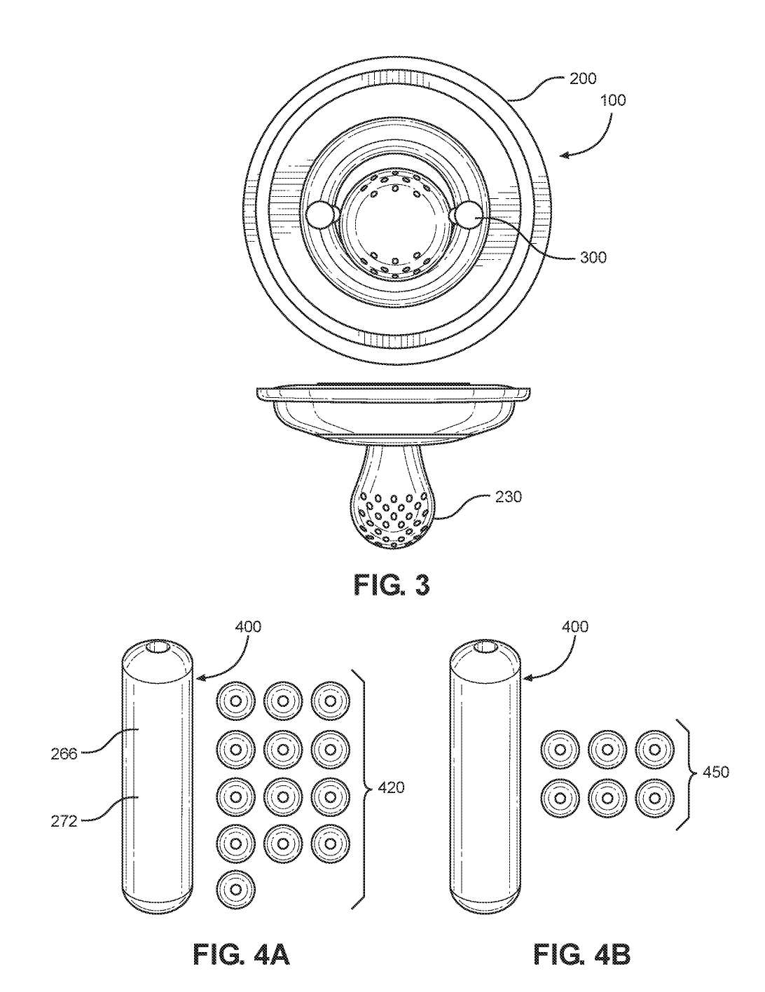

Referring now to FIGS. 1-5B, showing perspective views illustrating Improved Pacifier 100 according to an embodiment of the present invention of FIG. 1.

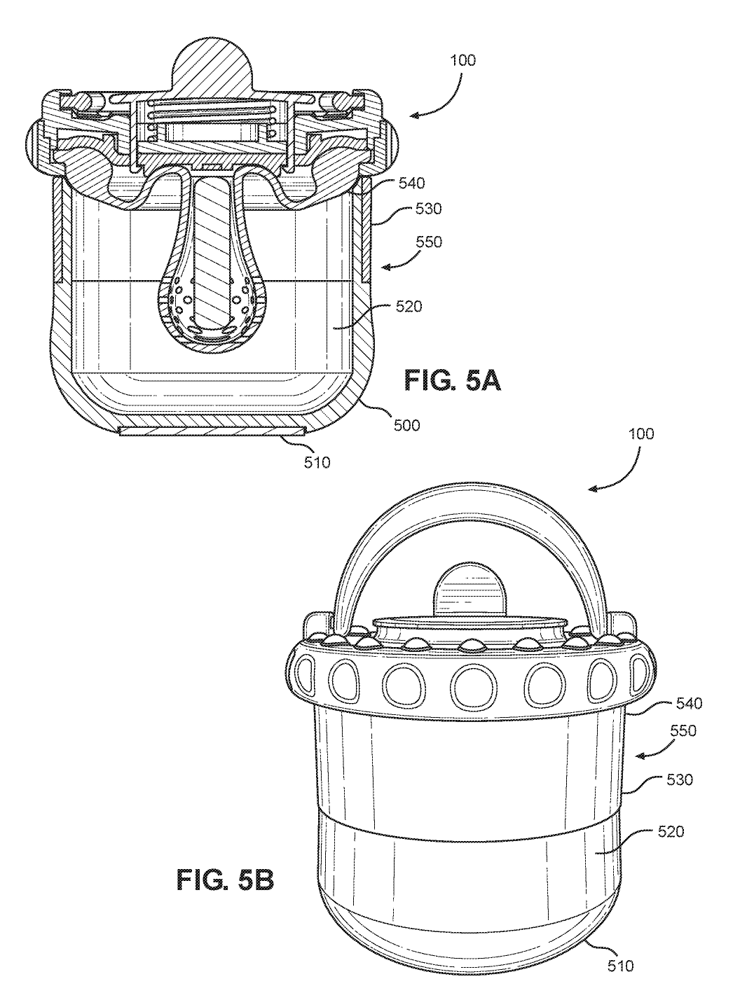

Improved pacifier assembly 100 comprising: pacifier 110 and storage cup 500 as shown in FIGS. 5A & 5B. Pacifier 110 includes handle assembly 200; teether member 230; at least one flavor packet 260; flavor packet cap 280; and bottom holder member 290.

Handle assembly 200 includes base plate 202 having outer ridge 206 and aperture 212 therethrough; cap member 216 having tab member 220; and handle member 226. Wherein base plate 202 of handle assembly 200 further includes at least one air hole 300 therethrough adapted to prevent a vacuum developing within pacifier 110 when in use. Wherein handle member 226 is connected to upper surface 204 of base plate 202. Wherein handle member 226 is pivotally connected to upper surface 204 of base plate 202 of handle assembly 200. Tab member 220 is adapted to be grabbed by a user and used to pull, push, and turn cap member 216. Wherein cap member 216 is adapted to releasably connect with base plate 202 to removably cover aperture 212 of base plate 202.

Teether member 230 includes: base portion 234 having outer ridge 236 and aperture 240 therethrough; and nipple portion 246 having outer membrane 248. Wherein outer membrane 248 forms an interior volume 250. Wherein outer membrane 248 includes plurality of perforations 252 therethrough. Wherein nipple portion 246 is connected to base portion 234 surrounding aperture 240 to thereby allowing flavor packet 260 to pass therethrough and into interior volume 250 thereof. Wherein aperture 240 is adapted to allow nipple portion 246 of teether member 230 to pass therethrough.

Wherein nipple portion 246 is formed from a flexible material. Wherein the flexible material is chosen from a list of materials consisting of latex, silicone, and plastic. Wherein nipple portion 246 can be formed having a size adapted for a particular age group. Wherein nipple portion 246 can be formed having first size 120 adapted for a baby between 0 and 6 months old as shown in FIG. 1A; and wherein nipple portion 246 can be formed having second size 130 adapted for a baby between 6 and 18 months old as shown in FIG. 1B.

At least one flavor packet 260 includes main material 266 and chemical additive 272. Wherein main material 266 is adapted to dissolve when mixed with saliva. Wherein main material 266 of at least one flavor packet 260 is formed from an organic material. Wherein main material 266 of at least one flavor packet 260 is formed from a material that is resistant to bacteria. Wherein main material 266 of at least one flavor packet 260 is formed from a material that meets FDA requirements. Wherein main material 266 of at least one flavor packet 260 is formed from a material that is adapted to dissolve in twenty-four hours. Wherein main material 266 of at least one flavor packet 260 is formed from a material that does not require refrigeration.

Wherein chemical additive 272 is adapted to provide a chosen flavor. Wherein chemical additive 272 is mixed with main material 266. Wherein each of at least one flavor packet 260 is adapted to be removably placed one at a time within interior volume 250 of nipple portion 246, such that when mixed with saliva flavor packet 260 dissolves and flows through plurality of perforations 252 of nipple portion 246.

Pacifier assembly 100 further comprising plurality of flavor packets 400, wherein each of plurality of flavor packets 400 includes a different chemical additive from the other flavor packets to thereby provide a variety of different flavors, such that flavor packets 400 can be removably interchanged depending on a choice of a particular flavor. Wherein there are fourteen flavor packets 420 as shown in FIG. 4A, wherein each of fourteen flavor packets 420 includes a different chemical additive from the other flavor packets 400 to thereby provide a variety of different flavors, such that flavor packets 400 can be removably interchanged depending on a choice of a particular flavor. Wherein each of plurality of flavor packets 400 is formed having a different color from the rest to thereby visually differentiate between differing flavors. Wherein there may also be seven flavor packets 450, wherein each of seven flavor packets 450 includes a different chemical additive from other flavor packets 400 to thereby provide a variety of different flavors, such that said flavor packets 400 can be removably interchanged depending on a choice of a particular flavor; and wherein seven flavor packets 450 are adapted to be used in succession within a seven day period.

Flavor packet cap 280 including aperture 282 therethrough. Wherein flavor packet cap 280 is adapted to reside between handle assembly 200 and teether member 230. Wherein flavor packet cap 280 further includes plurality of tab members 284 on outer ridge 286 thereof. Bottom holder member 290 includes outer ridge 292 and aperture 294 therethrough. Bottom holder member 290 further includes plurality of indentations 296 around an inner surface of outer ridge 292 thereof. Wherein each of said plurality of tab members 284 of flavor packet cap 280 are adapted to releasably engage a respective one of plurality of indentations 296 of bottom holder member 290 when bottom holder member 290 is connected with handle assembly 290. Wherein bottom holder member 290 is adapted to releasably connect with outer ridge 206 of base plate 202 of handle assembly 200 and hold teether member 230 and flavor packet cap 280 therebetween.

Storage cup 500 includes bottom wall 510 and at least one side wall 530 as shown in FIG. 5B. Wherein at least one side wall 530 is connected to bottom wall 510 and extending upwardly therefrom and includes upper edge portion 540. Wherein bottom wall 510 and at least one side wall 530 form interior volume 520 therein. Wherein bottom portion 298 of bottom holder member 290 of pacifier 110 is adapted to releasably engage upper edge portion 540 of at least one side wall 530 of storage cup 500, such that when in stored configuration 550 nipple portion 246 of teether member 230 is adapted to extend into interior volume 620 of storage cup 600 as shown in FIG. 5A.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An improved pacifier assembly comprising:
a pacifier comprising:
a handle assembly including:
a base plate including:
an outer ridge; and
an aperture therethrough;
a cap member including;
a tab member;
wherein said tab member is adapted to be grabbed by
a user and used to pull, push, and turn said cap member;
wherein said cap member is adapted to releasably connect with said base plate to removably cover said aperture of said base plate; and
a handle member;
wherein said handle member is connected to an upper surface of said base plate;
a teether member including:
a base portion including;
an outer ridge; and
an aperture therethrough; and
a nipple portion including:
an outer membrane;
wherein said outer membrane forms an interior volume;
wherein said outer membrane includes a plurality of perforations therethrough;
wherein said nipple portion is connected to said base portion surrounding said aperture to thereby allowing a flavor packet to pass therethrough and into said interior volume thereof;
at least one flavor packet including:
a main material ;
wherein said main material is adapted to dissolve when mixed with saliva; and
a chemical additive;
wherein said chemical additive is adapted to provide a chosen flavor;
wherein said chemical additive is mixed with said main material;
wherein each said at least one flavor packet is adapted to be removably placed one at a time within said interior volume of said nipple portion, such that when mixed with saliva said flavor packet dissolves and flows through said plurality of perforations of said nipple portion;
a flavor packet cap including;
an aperture therethrough;
wherein said flavor packet cap is adapted to reside between said handle assembly and said teether member; and
a bottom holder member including:
an outer ridge; and
an aperture therethrough;
wherein said aperture is adapted to allow said nipple portion of
said teether member to pass therethrough;
wherein said bottom holder member is adapted to releasably connect
with said outer ridge of said base plate of said handle assembly and hold said teether member and said flavor packet cap therebetween; and a storage cup including:
a bottom wall; and
at least one side wall
wherein said at least one side wall is connected to said bottom wall and extending upwardly therefrom and includes an upper edge portion;
wherein said bottom wall and said at least one side wall form an interior volume therein; and
wherein a bottom portion of said bottom holder member of said pacifier is adapted to releasably engage said upper edge portion of said at least one side wall of said storage cup, such that when in a stored configuration said nipple portion of said teether member is adapted to extend into said interior volume of said storage cup.

2. The pacifier assembly of claim 1, further comprising a plurality of flavor packets, wherein each of said plurality of flavor packets includes a different chemical additive from the other flavor packets to thereby provide a variety of different flavors, such that said flavor packets can be removably interchanged depending on a choice of a particular flavor.

3. The pacifier assembly of claim 1, wherein said nipple portion is formed from a flexible material.

4. The pacifier assembly of claim 1, wherein said flexible material is chosen from a list of materials consisting of latex, silicone, and plastic.

5. The pacifier assembly of claim 1, wherein said nipple portion can be formed having a size adapted for a particular age group.

6. The pacifier assembly of claim 1, wherein said flavor packet cap further includes a plurality of tab members on an outer ridge thereof; and said bottom holder member further includes a plurality of indentations around an inner surface of said outer ridge thereof; wherein each of said plurality of tab members of said flavor packet cap are adapted to releasably engage a respective one of said plurality of indentations of said bottom holder member when said bottom holder member is connected with said handle assembly.

7. The pacifier assembly of claim 1, wherein said handle member is pivotally connected to said upper surface of said base plate of said handle assembly.

8. The pacifier assembly of claim 1, wherein said base plate of said handle assembly further includes at least one air hole therethrough adapted to prevent a vacuum developing within said pacifier when in use.

9. The pacifier assembly of claim 2, wherein there are fourteen flavor packets, wherein each of said fourteen flavor packets includes a different chemical additive from the other flavor packets to thereby provide a variety of different flavors, such that said flavor packets can be removably interchanged depending on a choice of a particular flavor.

10. The pacifier assembly of claim 1, wherein said main material of said at least one flavor packet is formed from an organic material.

11. The pacifier assembly of claim 1, wherein said main material of said at least one flavor packet is formed from a material that is resistant to bacteria.

12. The pacifier assembly of claim 1, wherein said main material of said at least one flavor packet is formed from a material that meets FDA requirements.

13. The pacifier assembly of claim 2, wherein each of said plurality of flavor packets is formed having a different color from the rest to thereby visually differentiate between differing flavors.

14. The pacifier assembly of claim 1, wherein said main material of said at least one flavor packet is formed from a material that is adapted to dissolve in twenty-four hours.

15. The pacifier assembly of claim 1, wherein said main material of said at least one flavor packet is formed from a material that does not require refrigeration.

16. The pacifier assembly of claim 15, wherein said nipple portion can be formed having a first size adapted for a baby between 0 and 6 months old; and wherein said nipple portion can be formed having a second size adapted for a baby between 6 and 18 months old.

17. The pacifier assembly of claim 2, wherein there are seven flavor packets, wherein each of said seven flavor packets includes a different chemical additive from the other flavor packets to thereby provide a variety of different flavors, such that said flavor packets can be removably interchanged depending on a choice of a particular flavor; and wherein said seven flavor packets are adapted to be used in succession within a seven day period.
